(19) United States
(12) Patent Application Publication
(10) Pub. No.: US 2016/0355344 A1
(43) Pub. Date: Dec. 8, 2016

(54) CAVERN PRESSURE MANAGEMENT

(71) Applicant: Air Liquide Large Industries U.S. LP, Houston, TX (US)

(72) Inventor: Ronald STRYBOS, Kountze, TX (US)

(21) Appl. No.: 14/753,951

(22) Filed: Jun. 29, 2015

Related U.S. Application Data
(63) Continuation of application No. 14/732,171, filed on Jun. 5, 2015.

(51) Int. Cl. B65G 5/00

(52) U.S. Cl. CPC B65G 5/00

(57) ABSTRACT

A cavern pressure control method includes storing compressible and possibly incompressible fluids in an underground storage volume, removing a portion or introducing additional incompressible fluid into the underground storage volume, possibly removing a portion or introducing additional compressible fluid into the underground storage volume, thereby producing a net pressure decrease rate (P_{dec}) within the underground storage volume, wherein P_{dec} is maintained at less than a predetermined maximum decrease value (PDₘₐₓ).

### CROSS REFERENCE TO RELATED APPLICATIONS

This application is a continuation of U.S. patent application Ser. No. 14/732,171 filed Jun. 5, 2015, the entire contents of which are incorporated herein by reference.

### BACKGROUND

Hydrogen is commonly supplied to customers that are connected to a supplier's hydrogen pipeline system. Typically, the hydrogen is manufactured by steam methane reforming in which a hydrocarbon such as methane and steam are reacted at high temperature in order to produce a synthesis gas containing hydrogen and carbon monoxide. Hydrogen may then be separated from the synthesis gas to produce a hydrogen product stream that is introduced into the pipeline system for distribution to customers that are connected to the pipeline system. Alternatively, hydrogen produced Thorn the partial oxidation of a hydrocarbon can be recovered from a hydrogen rich stream.

Typically, hydrogen is supplied to customers under agreements that require availability and reliability for the steam methane reformer or hydrogen recovery plant. When a steam methane reformer is taken off-line for unplanned or extended maintenance, the result could be a violation of such agreements. Additionally, there are instances in which customer demand can exceed hydrogen production capacity of existing plants in the short term. Having a storage facility to supply back-up hydrogen to the pipeline supply is therefore desirable in connection with hydrogen pipeline operations.

Considering that hydrogen production plants on average have production capacities that are roughly 50 million standard cubic feet per day, a storage facility for hydrogen that would allow a plant to be taken off-line, to be effective, would need to have storage capacity in the order of 1 billion standard cubic feet or greater.

In order to provide this large storage capacity, high pressure gases, such as but not limited to nitrogen, air, carbon dioxide, hydrogen, helium, and argon, are stored in caverns, whether leached in salt formations or created by hard rock mining. A minimum volume of gas is stored in the cavern to provide adequate pressure to maintain the integrity of the cavern and prevent the cavern roof from collapsing and to keep the cavern walls from moving inward. This minimum volume of gas is called the pad gas or base gas. The amount of gas stored in addition to the pad gas or base gas volume is called the working gas or working inventory. Business opportunities can require removing more gas volume from the cavern than the working gas volume. To meet this business need, the volume of pad gas or base gas can be reduced to provide additional volume. For the purpose of this invention, the definition of high pressure is defined as a pressure at or above 10 atm. For the purpose of this invention, the definition of cavern integrity is defined as the ability of the cavern to hold static pressure when blocked in for 48 hours such that the cavern gas pressure does not decrease for 48 hours when all flows in and out of the cavern are stopped.

### SUMMARY

Another embodiment of the current invention includes storing a compressible fluid in an underground storage volume, and removing a portion of the compressible fluid into the underground storage volume, thereby producing a net pressure decrease rate (P_{dec}) within the underground storage volume, wherein P_{dec} is maintained at less than a predetermined maximum decrease value (PDₘₐₓ).

Another embodiment of the current invention includes storing a compressible fluid in an underground storage volume, storing an incompressible fluid in the underground storage volume, and removing a portion of the incompressible fluid from the underground storage volume, producing a net pressure decrease rate (P_{dec}) within the underground storage volume, wherein P_{dec} is maintained at less than a predetermined maximum decrease value (PDₘₐₓ).

Another embodiment of the present invention includes storing a compressible fluid in an underground storage volume, storing an incompressible fluid in the underground storage volume, removing a portion of the compressible fluid from the underground storage volume, and concurrently, introducing additional incompressible fluid into the underground storage volume, thereby producing a net pressure decrease rate (P_{dec}) within the underground storage volume, wherein P_{dec} is maintained at less than a predetermined maximum decrease value (PDₘₐₓ).

Another embodiment of the current invention includes storing a first compressible fluid in an underground storage volume, storing an incompressible fluid in the underground storage volume, introducing additional compressible fluid into the underground storage volume, and concurrently, removing a portion of the incompressible fluid from the underground storage volume, producing a net pressure decrease rate (P_{dec}) within the underground storage volume, wherein P_{dec} is maintained at less than a predetermined maximum increase value (PDₘₐₓ).

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Leached caverns in salt formations are used to store liquids and gases at various pressures. It is found that rapid pressure movements cause failure of the salt cavern structure such as the cavern walls or roof. By limiting the rate of pressure increase or decrease, the cavern structure can be maintained.

Rapid pressure increase or decrease in a salt storage cavern are found to cause stress on the salt cavern walls, leading to wall collapse and roof collapse.

As used herein, the terms “net pressure increase rate” and net pressure decrease rate” are defined as the difference between two pressure measurements that have been made after a lapsed time of one hour. This is not to be interpreted as an “instantaneous” rate change, i.e. the difference between two pressure measurements that have been made over a very short span of time (e.g. after a lapsed time of less than one minute). Likewise, this is not to be interpreted as a rate change measured over a fraction of an hour, and then interpolated to fit the time span of an entire hour. This is the net pressure change observed between the span of one hour.

In a first embodiment of the present invention, a method of pressure management in an underground storage volume is provided. This method includes storing a compressible fluid in an underground storage volume, and introducing additional compressible fluid into the underground storage volume, thereby producing a net pressure increase rate (P_{inc}) within the underground storage volume. P_{inc} is maintained at less than a predetermined maximum increase value (PIₘₐₓ).

Another embodiment of the current invention includes storing a compressible fluid in an underground storage volume, and removing a portion of the compressible fluid into the underground storage volume, thereby producing a net pressure decrease rate (P_{dec}) within the underground storage volume, wherein P_{dec} is maintained at less than a predetermined maximum decrease value (PDₘₐₓ).

In another embodiment of the current invention, the method includes storing a compressible fluid in an underground storage volume, storing an incompressible fluid in the underground storage volume, and introducing additional incompressible fluid into the underground storage volume, producing a net pressure increase rate (P_{inc}) within the underground storage volume, wherein P_{inc} is maintained at less than a predetermined maximum increase value (PIₘₐₓ).

Another embodiment of the current invention includes storing a compressible fluid in an underground storage volume, storing an incompressible fluid in the underground storage volume, and removing a portion of the incompressible fluid from the underground storage volume, producing a net pressure decrease rate (P_{dec}) within the underground storage volume, wherein P_{dec} is maintained at less than a predetermined maximum decrease value (PDₘₐₓ).

Another embodiment of the current invention includes storing a compressible fluid in an underground storage volume, storing an incompressible fluid in the underground storage volume, introducing additional compressible fluid into the underground storage volume, and concurrently, removing a portion of the incompressible fluid from the underground storage volume, thereby producing a net pressure increase rate (P_{inc}) within the underground storage volume, wherein P_{inc} is maintained at less than a predetermined maximum increase value (PIₘₐₓ).

Another embodiment of the present invention includes storing a compressible fluid in an underground storage volume, storing an incompressible fluid in the underground storage volume, removing a portion of the compressible fluid from the underground storage volume, and concurrently, introducing additional incompressible fluid into the underground storage volume, thereby producing a net pressure decrease rate (P_{dec}) within the underground storage volume, wherein P_{dec} is maintained at less than a predetermined maximum decrease value (PDₘₐₓ).

Another embodiment of the current invention includes storing a first compressible fluid in an underground storage volume, storing an incompressible fluid in the underground storage volume, removing a portion of the compressible fluid from the underground storage volume, and concurrently, introducing additional incompressible fluid into the underground storage volume, producing a net pressure increase rate (P_{inc}) within the underground storage volume, wherein P_{inc} is maintained at less than a predetermined maximum increase value (PIₘₐₓ).

Another embodiment of the current invention includes storing a first compressible fluid in an underground storage volume, storing an incompressible fluid in the underground storage volume, introducing additional compressible fluid into the underground storage volume, and concurrently, removing a portion of the incompressible fluid from the underground storage volume, producing a net pressure decrease rate (P_{dec}) within the underground storage volume, wherein P_{dec} is maintained at less than a predetermined maximum increase value (PDₘₐₓ).

PIₘₐₓ may be 100 psi/hr. PIₘₐₓ may be 75 psi/hr. The underground storage volume may be an underground salt cavern. The compressible fluid may be selected from the group consisting of nitrogen, air, carbon dioxide, hydrogen, helium, and argon. The incompressible fluid may be selected from the group consisting of brine, water, or water slurry.

1. A method of pressure management in an underground storage volume, comprising:
storing a compressible fluid in an underground storage volume,
storing an incompressible fluid in said underground storage volume,
and performing one of the following:
removing a portion of said compressible fluid from said underground storage volume, thereby producing a net pressure decrease rate (P_{dec}) within said underground storage volume,
removing a portion of said compressible fluid from said underground storage volume, and concurrently, introducing additional incompressible fluid into said underground storage volume, thereby producing a net pressure decrease rate (P_{dec}) within said underground storage volume,
introducing additional compressible fluid into said underground storage volume, and concurrently, removing a portion of said incompressible fluid from said underground storage volume, producing a net pressure decrease rate (P_{dec}) within said underground storage volume,
wherein P_{dec} is maintained at less than a predetermined maximum decrease value (PDₘₐₓ).

2. The method of claim 1, wherein said underground storage volume is an underground salt cavern.

3. The method of claim 1, wherein said compressible fluid is selected from the group consisting of nitrogen, air, carbon dioxide, hydrogen, helium, and argon.

4. The method of claim 3, wherein said compressible fluid is hydrogen.

5. The method of claim 1, wherein said incompressible fluid is selected from the group consisting of brine, water, and water slurry.

6. The method of claim 1, wherein PDₘₐₓ is 20 psi/hr.

7. The method of claim 1, wherein PDₘₐₓ is 15 psi/hr.
